(19) United States
(12) Patent Application Publication
(10) Pub. No.: US 2018/0341149 A1
(43) Pub. Date: Nov. 29, 2018

(54) TRANSPARENT LIQUID CRYSTAL DISPLAY PANEL AND DISPLAY DEVICE COMPRISING THE SAME

(71) Applicant: SHENZHEN CHINA STAR OPTOELECTRONICS TECHNOLOGY CO., LTD., Shenzhen, Guangdong (CN)

(72) Inventor: Lixuan Chen, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 15/329,362

(22) PCT Filed: Jan. 13, 2017
(86) PCT No.: PCT/CN2017/071142

§ 371 Date: Sep. 29, 2017

(30) Foreign Application Priority Data
Dec. 26, 2016 (CN) 201611217143.3

(51) Int. Cl. G02F 1/1335

(52) U.S. Cl. CPC G02F 1/133528; G02F 2001/133531; G02F 2201/305; G02F 2001/133567; G02F 2001/133538; G02F 2001/133562

(57) ABSTRACT

Disclosed is a transparent liquid crystal display panel which includes an upper substrate and a lower substrate. The upper substrate includes a pixel structure and an upper polarizing structure from bottom to top, and the lower substrate includes a lower polarizing structure. The pixel structure includes an active area and a transparent area. A direction of a grating bar of the upper polarizing structure corresponding to the active area is perpendicular to a direction of grating bars of the lower polarizing structure, and a direction of a grating bar of the upper polarizing structure corresponding to the transparent area is parallel to the direction of the grating bars of the lower polarizing structure. The display panel has advantages that the transmittance of the transparent liquid crystal display device is adjustable, the number of control points of a pixel signal voltage is reduced, and the complexity of a manufacture process is reduced.

### CROSS-REFERENCE TO RELATED APPLICATIONS

This application claims the priority of Chinese patent application CN 201611217143.3, entitled “Transparent liquid crystal display panel and display device comprising the same” and filed on Dec. 26, 2016, the entirety of which is incorporated herein by reference.

### FIELD OF THE INVENTION

The present disclosure relates to the technical field of liquid display, and in particular, to a transparent liquid crystal display panel and a display device comprising the same.

### BACKGROUND OF THE INVENTION

A transparent display panel refers to a display device that provides a transparent display state so that viewers can see a scene behind the display device. Transparent display panels are often used in shop windows or vending machines for displaying images of physical articles. They can also be used on glass in small-scale display devices. At present, transparent display panels are mainly based on LCD (Liquid Crystal Display) technology, OLED (Organic Light Emitting Diode) technology, and PDP (Plasma Display Panel) technology. In a transparent display device based on LCD technology, a pixel structure is divided into two areas, an active area and a transparent area, and a transparent light guide plate and a liquid crystal material such as PDLC (Polymer Dispersed Liquid Crystal)/PNLC (Polymer Network Liquid Crystal) having a scattering/transmission state at different voltages are adopted. The techniques described above are applied to transparent liquid crystal display devices. According to the pixel structure dividing technique, the active area can provide a display panel for viewing, and the transparent area is in a transparent state so that a viewers can see a scene behind the display panel.

A pitch of a subwavelength grating is much smaller than a wavelength of an incident light, and there are only zero-order diffracted waves, high-order diffracted waves being evanescent waves. Therefore, unique diffraction properties of the subwavelength grating can realize many special functions that cannot be realized by many traditional optical devices. Since the subwavelength grating has excellent optical diffraction properties, it is widely used in many fields such as optical sensing, optical integration, and optical holography.

Polarization properties of a subwavelength grating are determined by the material and structure of the grating. Structure parameters of a grating mainly include the width, the depth, and the pitch of the grating. According to influences of different materials, surface types, and structure parameters of gratings on TM polarization transmittance and transmission extinction ratios, different subwavelength grating polarizers can be designed. When the grating pitch is sufficiently small, especially if the grating pitch is much smaller than the wavelength of an incident light (e.g., a visible wavelength ranges from 400 nm to 800 nm), the grating can almost completely reflect the light of the electric field vector component vibrating in parallel with the grating, and the light of the electric field vector component vibrating in perpendicular to the grating can almost completely pass though. The smaller the grating pitch is, the better a polarization effect is. The larger the grating pitch is, the lower the transmittance of a short wavelength is. Therefore, with its high transmittance and high reliability, subwavelength grating polarizers can be used in liquid crystal display devices to replace traditional polymer film polarizers.

Chinese patent application CN 201610518383.0 has disclosed a subwavelength grating polarizer and a method for manufacturing the same. It is known from this patent that the application of subwavelength grating polarizing structures to display devices in place of ordinary polarizers can achieve a better display effect.

According to the design of a current transparent display, when a transparent area (T) is controlled by a single pixel signal voltage, a whole pixel is supplied with at least four groups of pixel signal voltages (R+G+B+T) which control output of a control signal. When the transparent area (T) is designed individually beside an R/G/B sub-pixel, up to six groups of pixel signal voltages (R+T(R)+G+T (G)+B+T (B)) for controlling the output of the control signal are supplied.

The active area and the transparent area are controlled by their respective pixel signal voltages, so that image effects can be controlled in real time. However, the increase of the number of control points of a pixel signal voltage may lead to defects such as: 1. decrease of aperture ratio of the entire panel; 2. increase of signal output; and 3. increase of the complexity of a system.

In order to solve the above problems, it is necessary to provide a new transparent display panel.

### SUMMARY OF THE INVENTION

A transparent liquid crystal display device provided by the present disclosure has advantages that the transmittance thereof is adjustable, the number of control points of a pixel signal voltage is reduced, and the complexity of a manufacturing process thereof is reduced.

The present disclosure provides a transparent liquid crystal display panel which comprises an upper substrate and a lower substrate. The upper substrate comprises a pixel structure and an upper polarizing structure from bottom to top, and the lower substrate comprises a lower polarizing structure. The pixel structure comprises an active area and a transparent area. A direction of a grating bar of the upper polarizing structure corresponding to the active area is perpendicular to a direction of grating bars of the lower polarizing structure, and a direction of a grating bar of the upper polarizing structure corresponding to the transparent area is parallel to the direction of the grating bars of the lower polarizing structure.

The active area and the transparent area are alternately arranged.

The active area comprises a red (R) sub-pixel, a green (G) sub-pixel, and a blue

(B) sub-pixel from left to right.

The upper polarizing structure and the lower polarizing structure are subwavelength gratings.

The upper polarizing structure and the lower polarizing structure can be provided on a flexible substrate or on a glass substrate.

In the upper polarizing structure and the lower polarizing structure, a ratio of a grating depth to a grating pitch is from 1:1 to 6:1.

The grating depth is between 100 nm and 350 nm. and the grating pitch is less than 300 nm.

The transparent liquid crystal display panel comprises a first signal configured to control the transparent area and a second signal configured to control the active area, or comprises a first signal configured to control both the transparent area and the active area.

A voltage of the first signal is a maximum value of voltages of the R sub-pixel, the G sub-pixel or the B sub-pixel signal, or an average value of the voltages of the R sub-pixel, the G sub-pixel, and the B sub-pixel.

The present disclosure further provides a display device comprising a transparent liquid crystal display panel. The transparent liquid crystal display panel comprises an upper substrate and a lower substrate. The upper substrate comprises a pixel structure and an upper polarizing structure from bottom to top, and the lower substrate comprises a lower polarizing structure. The pixel structure comprises an active area and a transparent area. A direction of a grating bar of the upper polarizing structure corresponding to the active area is perpendicular to a direction of grating bars of the lower polarizing structure, and a direction of a grating bar of the upper polarizing structure corresponding to the transparent area is parallel to the direction of the grating bars of the lower polarizing structure.

The active area and the transparent area are alternately arranged.

The active area and the transparent area are alternately arranged.

The active area comprises an R sub-pixel, a G sub-pixel, and a B sub-pixel from left to right.

The upper polarizing structure and the lower polarizing structure are subwavelength gratings.

In the upper polarizing structure and the lower polarizing structure, a ratio of a grating depth to a grating pitch is from 1:1 to 6:1.

The grating depth is between 100 nm and 350 nm, and the grating pitch is less than 300 nm.

The present disclosure has the advantages that an aperture ratio of an entire transparent liquid crystal display panel can be improved, the signal output can be reduced, and the complexity of a system can be reduced. At the same time, the transmittance of a transparent liquid crystal display device is made adjustable, which reduces the number of control points of a pixel signal voltage.

The above technical features can be combined in any suitable manner, or substituted by the equivalent technical features, as long as the purpose of the present disclosure can be achieved.

### BRIEF DESCRIPTION OF THE DRAWINGS

The present disclosure will be described in a more detailed way below based on embodiments and with reference to the accompanying drawings, in which:

FIG. 1 schematically shows a structure of a transparent liquid crystal display panel in the present disclosure;

FIG. 2 shows a top view of an upper polarizing structure in the present disclosure;

FIG. 3 shows an upward view of the lower polarizing structure in the present disclosure;

FIG. 4 shows a perspective view of the upper polarizing structure in the present disclosure;

FIG. 5 shows a perspective view of the lower polarizing structure in the present disclosure;

FIG. 6 schematically shows a structure of subwavelength metal gratings of the upper polarizing structure and the lower polarizing structure in one preferable embodiment of the present disclosure;

FIG. 7 shows a top view of the structure of the subwavelength gratings of the upper polarizing structure in a normally black mode in the present disclosure; and

FIG. 8 shows an upward view of the structure of the subwavelength gratings of the lower polarizing structure in a normally black mode in the present disclosure.

In the accompanying drawings, same components use same reference signs. The accompanying drawings are not drawn according to actual proportions.

### DETAILED DESCRIPTION OF THE EMBODIMENTS

The present disclosure will be further described below with reference to the accompanying drawings.

The present disclosure provides a transparent liquid crystal display device, in order to make the transmittance of the transparent liquid crystal display device adjustable, to reduce the number of control points of a pixel signal voltage, and to reduce the complexity a manufacture process.

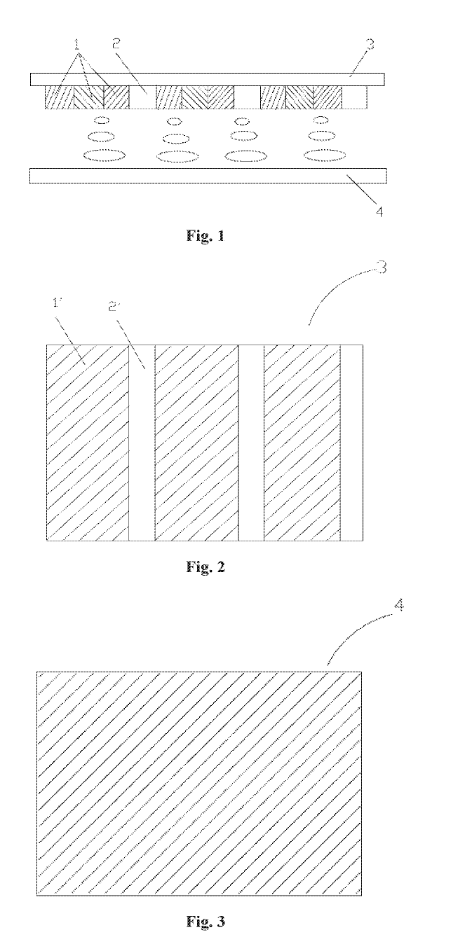

The present disclosure provides a transparent liquid crystal display panel as shown in FIG. 1. The transparent liquid crystal display panel comprises an upper substrate and a lower substrate. The upper substrate comprises a pixel structure and an upper polarizing structure 3. An R sub-pixel, a G sub-pixel, a B sub-pixel, and a blank sub-pixel form a pixel unit. The pixel structure of the liquid crystal display panel of the present disclosure is composed of a plurality of the pixel units. The lower substrate comprises a lower polarizing structure 4. The pixel structure of the upper substrate comprises an active area 1 and a transparent area 2. A ratio of a width of the active area 1 to a width of the transparent area 2 is not fixed, but the active area 1 and the transparent area 2 are alternately arranged in structure.

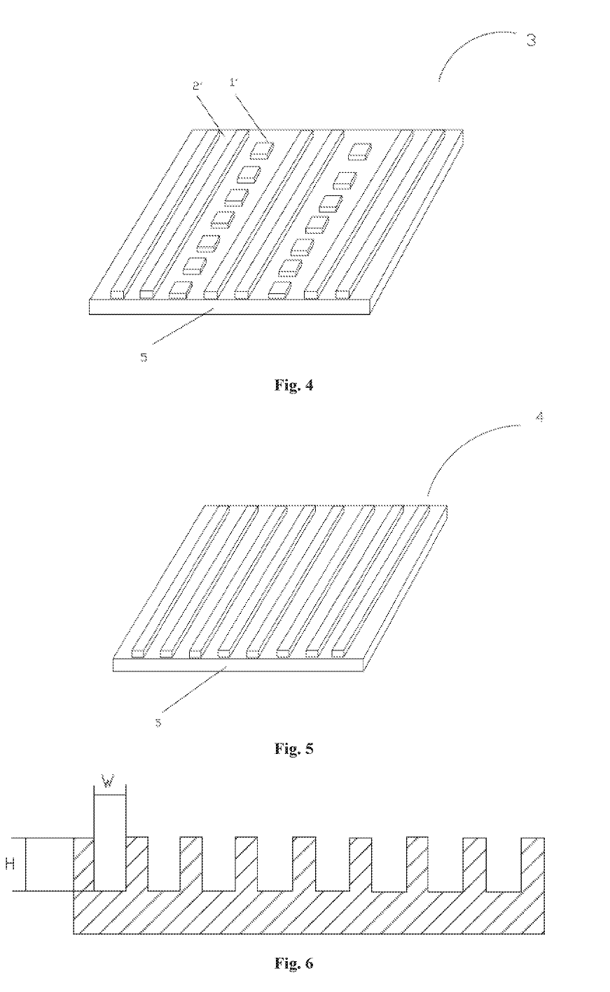

As shown in FIGS. 4 and 5, the upper polarizing structure 3 of the upper substrate and the lower polarizing structure 4 of the lower substrate can be manufactured on a PET flexible substrate 5 (or a glass substrate). The upper polarizing structure 3 and the lower polarizing structure 4 can be attached on the flexible substrate 5 like a conventional polarizer, or manufactured on the glass substrate 5.

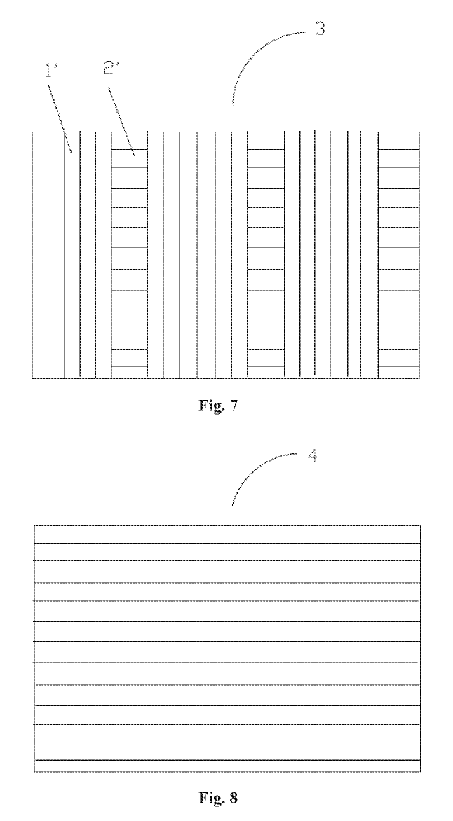

The upper polarizing structure 3 and the lower polarizing structure 4 are further described with reference to FIG. 6. The upper polarizing structure 3 and the lower polarizing structure 4 of the present disclosure are subwavelength gratings. In a preferred embodiment, subwavelength metal gratings are used. A ratio of a grating depth H to a grating pitch W is from 1:1 to 6:1. The grating depth H is between 100 nm and 350 nm, and the grating pitch W is less than 300 nm.

Further, as shown in FIGS. 2 and 3, the active area 1 of the upper substrate corresponds to a grating bar 1′ of the upper polarizing structure 3, while the transparent area 2 of the upper substrate corresponds to a grating bar 2′ of the upper polarizing structure 3. The grating bars of the upper polarizing structure 3 have different directions, i.e., grating bars 1′ and grating bars 2′ have different directions. As shown in FIGS. 7 and 8, the grating bars 1′ are perpendicular to grating bars of the lower polarizing structure 4, while the grating bars 2′ are parallel to the grating bars of the lower polarizing structure 4. When normally black mode liquid crystals are used, since grating bars 1′ and grating bars of the lower polarizing structure 4 are perpendicular to each other, an incident light cannot pass through pixel regions of the R sub-pixels, the G sub-pixels, and the B sub-pixels when there is no voltage, and therefore a black screen is caused. The grating bars 2′ and the grating bars of the lower polarizing structure 4 are parallel to each other; light can therefore pass through the transparent area 2 when there is no voltage.

According to the above design, the transmittance of the transparent area 2 of the transparent display device is gradually reduced with the increase of a liquid crystal driving voltage at a corresponding portion, so that the transparent display device exhibits a better transparency at darker picture regions, and a lower transparency and higher color saturation in brighter picture regions.

The transparent area 1 can be separately provided with a pixel signal, or share signals of the R sub-pixel, the G sub-pixel, and the B sub-pixel. A pixel signal voltage of the transparent area 1 is a maximum value of voltages of the R sub-pixel, the G sub-pixel or the B sub-pixel signal, or an average value of the voltages of the R sub-pixel, the G sub-pixel, and the B sub-pixel.

The present disclosure further provides a transparent display device which comprises a transparent liquid crystal display panel of the above characteristics.

The present disclosure has the advantages that an aperture ratio of an entire transparent liquid crystal display panel can be improved, the signal output can be reduced, and the complexity of a system can be reduced. The most critical is that the present disclosure makes the transparent liquid crystal display transmittance adjustable, which reduces the number of control points of a pixel signal voltage.

The present disclosure is illustrated in detail in combination with preferred embodiments hereinabove, but it can be understood that the embodiments disclosed herein can be improved or substituted without departing from the protection scope of the present disclosure. In particular, as long as there are no structural conflicts, the technical features disclosed in each and every embodiment of the present disclosure can be combined with one another in any way, and the combined features formed thereby are within the protection scope of the present disclosure. The present disclosure is not limited by the specific embodiments disclosed herein, but includes all technical solutions falling into the protection scope of the claims.

1. A transparent liquid crystal display panel, comprising an upper substrate and a lower substrate,
wherein, the upper substrate comprises a pixel structure and an upper polarizing structure from bottom to top, and the lower substrate comprises a lower polarizing structure;
wherein, the pixel structure comprises an active area and a transparent area; and
wherein, a direction of a grating bar of the upper polarizing structure corresponding to the active area is perpendicular to a direction of grating bars of the lower polarizing structure, and a direction of a grating bar of the upper polarizing structure corresponding to the transparent area is parallel to the direction of the grating bars of the lower polarizing structure.

2. The transparent liquid crystal display panel according to claim 1, wherein the active area and the transparent area are alternately arranged.

3. The transparent liquid crystal display panel according to claim 1, wherein the active area comprises a red sub-pixel, a green sub-pixel, and a blue sub-pixel from left to right.

4. The transparent liquid crystal display panel according to claim 1, wherein the upper polarizing structure and the lower polarizing structure are subwavelength gratings.

5. The transparent liquid crystal display panel according to claim 4, wherein the upper polarizing structure and the lower polarizing structure can be provided on a flexible substrate or on a glass substrate.

6. The transparent liquid crystal display panel according to claim 5, wherein, in the upper polarizing structure and the lower polarizing structure, a ratio of a grating depth to a grating pitch is from 1:1 to 6:1.

7. The transparent liquid crystal display panel according to claim 6, wherein the grating depth is between 100 nm and 350 nm, and the grating pitch is less than 300 nm.

8. The transparent liquid crystal display panel according to claim 1, further comprising a first signal configured to control the transparent area and a second signal configured to control the active area, or comprising a first signal configured to control both the transparent area and the active area.

9. The transparent liquid crystal display panel according to claim 8, a voltage of the first signal is a maximum value of signal voltages of the red sub-pixel, the green sub-pixel or the blue sub-pixel, or an average value of the signal voltages of the red sub-pixel, the green sub-pixel, and the blue sub-pixel.

10. A display device comprising a transparent liquid crystal display panel, wherein, the transparent liquid crystal display panel comprises an upper substrate and a lower substrate,
wherein the upper substrate comprises a pixel structure and an upper polarizing structure from bottom to top, and the lower substrate comprises a lower polarizing structure;
wherein the pixel structure comprises an active area and a transparent area; and
wherein a direction of a grating bar of the upper polarizing structure corresponding to the active area is perpendicular to a direction of grating bars of the lower polarizing structure, and a direction of a grating bar of the upper polarizing structure corresponding to the transparent area is parallel to the direction of the grating bars of the lower polarizing structure.

11. The display device according to claim 10, wherein the active area and the transparent area are alternately arranged.

12. The display device according to claim 11, wherein the active area and the transparent area are alternately arranged.

13. The display device according to claim 10, wherein the active area comprises a red sub-pixel, a green sub-pixel, d a blue sub-pixel from left to right.

14. The display device according to claim 10, wherein the upper polarizing structure and the lower polarizing structure are subwavelength gratings.

15. The display device according to claim 14, wherein, in the upper polarizing structure and the lower polarizing structure, a ratio of a grating depth to a grating pitch is from 1:1 to 6:1.

16. The display device according to claim 15, wherein the grating depth is between 100 nm and 350 nm, and the grating pitch is less than 300 nm.
